(19) United States
(12) Patent Application Publication
(10) Pub. No.: US 2002/0103679 A1
(43) Pub. Date: Aug. 1, 2002

(54) Insurance system and method with disproportional allocation

(76) Inventors: Swinton B. Burkhalter, Atlanta, GA (US); Frank M. Sexton, Atlanta, GA (US)

Correspondence Address: Joseph H. Golant, 77 West Wacker Drive, Suite 3500, Chicago, IL, 60601-1692, US

(21) Appl. No.: 09/775,336

(22) Filed: Feb. 1, 2001

(51) Int. Cl. G06F 17/60

(52) U.S. Cl. 705/4

(57) ABSTRACT

An insurance method and system concerning two or more separate but related insurance contracts where one of the contracts is a life policy and the other contract is a long-term care product are disclosed. The life insurance product includes all types of life insurance contracts on the market today (and those developed in the future) and the long-term care products include all non-life insurance policies on the market today (and those developed in the future).

### BACKGROUND OF THE INVENTION

1. Field of the Invention

The present invention relates to an insurance plan and more particularly to an insurance method and system using two or more separate but related insurance contracts.

2. Description of the Related Art

Individually issued life insurance policies are often used to provide supplementary benefits to selected employees. The employees typically are those whose skills, talents and experience make them valuable assets for the business. Through insurance, the employer can provide benefits beyond those offered to other employees. The object, of course, is to attract and retain talented employees by rewarding them in special ways. These plans are typically “non-qualified” which means that the employer makes no effort to meet the qualifications of the Internal Revenue Code for favorable tax treatment for the costs or benefits of the plans. A qualified plan must meet certain non-discrimination requirements as well as a host of other standards.

In the 1950s the significance of separating the various values and benefits of a single life policy into component parts was recognized. This allowed two different entities such as an employer and an employee to share the premiums and benefits of a single policy. Such shared policies became known in the insurance industry as “split-dollar” insurance. While the insurance contract was between the policy holder and the issuing company, the premium and benefits allocation was contractually established by a separate written agreement between two difference entities such as the employer and the employee.

Split-dollar insurance is an arrangement for providing funding for individually issued, cash-value life insurance. It is a funding method, not a type of policy. The written agreement divides or splits the death benefits, the living benefits (cash values) and the premium obligation between two parties—hence the name “split-dollar insurance.” The objective of split-dollar plans is to join together the insurance needs of one person with the premium paying ability of another. Often this means cooperation between an employee and his/her employer, but the concept can also be applied to a number of other relationships, such as child-parent, stockholder-corporation, buyer-seller, charity-donor, trust-grantor, charity-trust, etc.

The split-dollar plans may provide employees with substantial amounts of life insurance protection, generally at a cost well below that which they would pay for the same policies purchased individually. When used as a fringe benefit, split-dollar insurance proceeds are usually intended first as a death benefit to the employee's beneficiary and second as a reimbursement to the employer for its share of premiums paid.

Under a split-dollar arrangement, employer and employee join in the purchase of a cash-value containing life insurance contract on the employee's life. Typically the employer provides the funds to pay that part of each annual premium that is equal to the annual increase in the cash value of the policy. The employee pays the balance. The employer is entitled to receive death proceeds from the policy equal to the cash value, or at least a sufficient amount so as to equal its total premium payments. The employee names the beneficiary for the balance of death proceeds. Although the employee's share of annual premiums may be substantial in the early years of a policy, it will decrease each year as the annual increases in cash value grow progressively larger. In many cases the employee's premium share reaches zero after a relatively short time.

As the employer takes over more of the obligation to pay premiums, its share of the death proceeds increases. Nevertheless, through the appropriate use of dividends or other options, the employee's share of the death benefit to the beneficiary often can be maintained at an approximately constant amount. If it is desirable for the employee instead of the employer to have rights to the cash value and for the employer, instead of the employee, to control the disposition of the death proceeds, a “reverse split-dollar” plan is created. The traditional role of the employer and employee are simply reversed.

Though generally popular, several drawbacks to the split-dollar plan exist. First, there are always problems of contract interpretation between the parties to the plan. Second, there are a number of applicable Internal Revenue Service rulings, technical advisory memorandums, private letter rulings and tax court cases to be reviewed and analyzed to determine tax consequences. Third, the marketing, sale and administration of split-dollar plans are difficult and expensive because they are complicated to install and administer, difficult to understand and because they require the services of accountants and lawyers.

Another previous insurance product was referred to as a “Section 79 Plan”. This was a group term life insurance plan under Section 79 of the Internal Revenue Code (and thus a qualified plan) whereby the employer paid the premiums. The employee, however, must report as gross income, the cost of insurance for the amount of death benefit over $50,000. When properly arranged, the cost of the premium is also fully deductible by the employer. The Section 79 Plan was designed as a way to provide permanent life insurance under group life insurance tax regulations. While the insurance plans discussed above call for one contract containing all values and benefits, a few companies under Section 79 Plans designed a two policy plan in which one of the policies was a decreasing term contract and the other was an increasing death benefit permanent contract. Each contract, however, had its own independent premiums and policy values and they were not related. The policies did, however, insure the same individual.

Even though two policies were used, the method of determining premiums, expenses and benefits for each policy was traditional. The premiums and policy values were fixed by the issuing company and could not be divided differently for differing situations. The two contracts were very similar to existing products in the marketplace in that the term plan looked and performed like many other decreasing term life insurance contracts and the permanent increasing death benefit contract performed similar to an annuity or an endowment contract. Subsequent tax laws and regulations have severely restricted Section 79 plans so that today no companies are known to actively market products of this type. Also, Section 79 plans were not suited for split-dollar arrangement and were not used for such applications.

In applicants' earlier patent, U.S. Pat. No. 5,752,236 (“'236 patent”), the disclosure of which is incorporated herein by reference, life insurance plans were described where death benefits, premium obligations, policy expense, and cash values, if any, were divided between two or more contracts or policies on the same insured or insureds. It was disclosed that more of the policy expenses and premium obligations were assigned to one of the two (or more) separate but related contracts while more of the death benefits and cash values, if any, were assigned to the other (or others) of the remaining contracts. It was further disclosed that the death benefits and cash values of all contracts were a function of the premiums paid on all of the related contracts.

### BRIEF SUMMARY OF THE INVENTION

What is described here is a method for forming an insurance plan comprising the steps of collecting base product data, inputting the base product data into a data processing apparatus, collecting data about an individual to be insured, inputting the data about the individual into a data processing apparatus, collecting regulatory requirements, inputting the regulatory requirements into a data processing apparatus, choosing or forming a life insurance product, inputting the life insurance product choice into a data processing apparatus, choosing or forming a long-term care insurance product, inputting the long-term care insurance product of choice into a data processing apparatus, forming at least two separate but related policies in a data processing apparatus, disproportionately dividing benefits and obligations regarding the separate but related policies, comparing the policies with the regulatory requirements, determining ownership, beneficiary and premium obligor and displaying the resulting policies.

What also is described here is an insurance system comprising a data processing apparatus having input means for receiving information and instructions, the data processing apparatus having base product data, regulatory requirements and information concerning a prospective insured, the data processing apparatus also having information concerning a life insurance product and a long-term care product, the data processing apparatus further having inputted instructions allocating premium obligations in a disproportional manner between at least one life insurance contract and at least one long-term care contract and means connected to the data processing apparatus for displaying the resulting related contracts.

It is an object of the present invention to provide a high performance life insurance policy complete with riders and options and with inherent tax advantages which is discounted because of a related policy. Another aim of the present invention is to provide an insurance method which reallocates policy expenses so as to result in higher tax deductibility in those situations where companion policies are normally deductible as a business expense. It is another advantage of the present invention to provide an insurance method with greater efficiencies for insurance companies. Yet another aim of the present invention to provide an insurance system for enhancing insurance coverage for selected individuals. A further feature of the present invention is the provision of two or more related individual policies of which one is a high performance policy that is simple to understand and requires no additional contract, nor the services of a lawyer or CPA advisor.

A more complete understanding of the present invention and other objects, aspects, aims and advantages thereof will be gained from the consideration of the following description of the preferred embodiments read in conjunction with the accompanied drawing provided herein.

### BRIEF DESCRIPTION OF THE DRAWING

FIG. 1 is a flow diagram illustrating the present invention.

FIG. 2 is another flow diagram illustrating the present invention.

### DETAILED DESCRIPTION OF THE INVENTION

While the present invention is open to various modifications and alternative constructions, the preferred embodiments shown in the drawing will be described herein in detail. It is understood however that there is no intention to limit the invention to the particular forms disclosed. On the contrary, the intention is to cover all modifications, equivalent structures and methods, and alternative constructions falling within the spirit and scope of the invention as expressed in the appended claims.

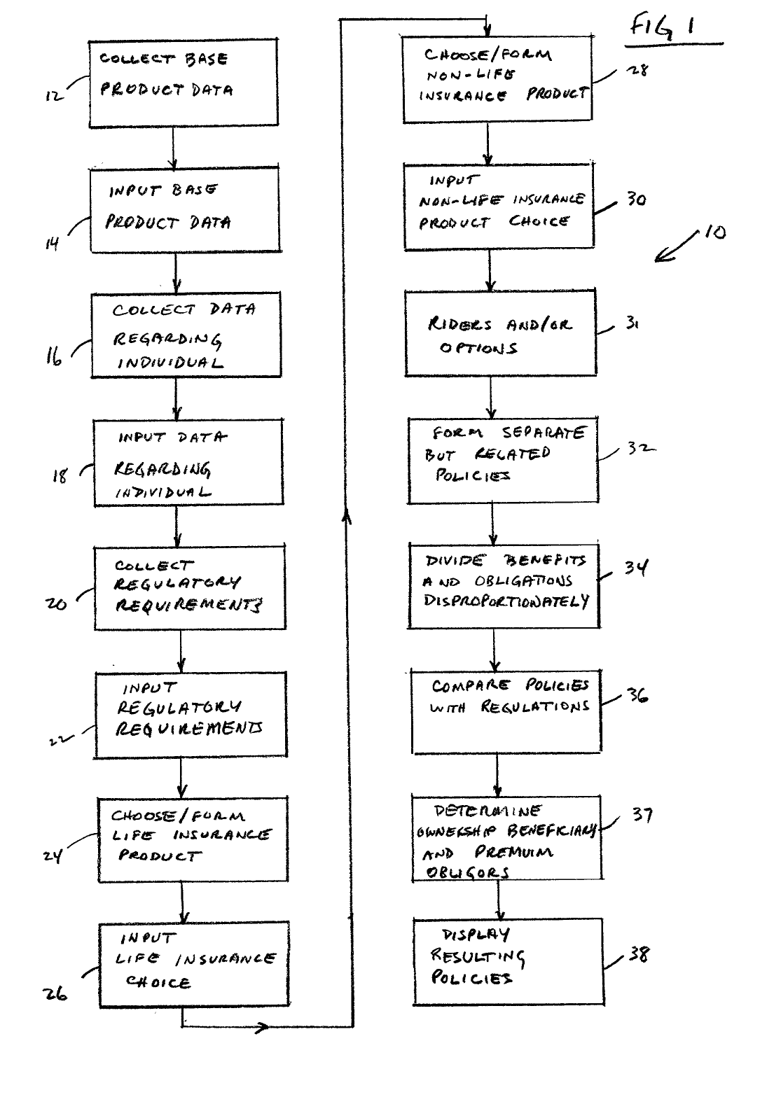

Referring now to FIG. 1, the method for forming an insurance plan 10 includes collecting Base Product Data, such data being represented by block 12. Base Product Data includes such information as the probability of the event insured against occurring, the time value of money, the benefits promised, insurance company expenses, and the desired profits and probable contingencies. Base Product Data may be used to create a new policy, or such data may already have been used to create a policy and that policy may be modified or used as is. Inputting the Base Product Data into a data processing apparatus, such as a computer, is represented by block 14. These two steps may be replaced by the selection of a policy if one already exists, since it is based on Base Product Data. There is also a need to collect data regarding an individual who is to be insured. This is represented by block 16. The information required about an individual to be insured may include his/her sex, age, marital status, individual medical history, family medical history, usage of alcohol, tobacco and drugs, automobile driving record, credit report, financial statement, criminal record, current medical examination report and results, and physical disabilities and impairments. Information about the individual is inputted 18 into the data processing apparatus.

The next step includes collecting regulatory requirements 20, such as those in the Internal Revenue Codes and in various state codes and statutes. Regulatory requirements generally mean that insurance contracts comply or qualify under applicable law such as Section 7702 of the Internal Revenue Code. Section 7702 states a test that has two alternatives and whichever alternative is chosen, that test must be met for the entire life of the contract. The first test applies mainly to traditional cash-value policies. This cash-value accumulation test requires that, by the terms of the contract, the cash surrender value cannot at any time exceed the net single premium required to fund future contract benefits. The net single premium is calculated by assuming an interest rate equal to the greater of 4% or the rate guaranteed in the contract. The mortality charges are based on those specified in the contract, or, if not specified, the mortality charges used in determining statutory reserves for that contract. For contracts issued after Oct. 20, 1988, the mortality charges must be reasonable and cannot exceed those of the prevailing mortality tables required by state insurance regulators.

The second test intended for universal life, variable universal life and related policies requires that both a guideline premium and a death benefit test be met. The guideline premium requirement is met if accumulated premiums paid under the contract do not exceed, at any time, the greater of the “guideline single premium” or the sum of the “guideline level premiums” at the time. The guideline single premium is computed using interest at the greater rate of 6% or the rate guaranteed in the contract. Mortality charges are based on the same standard as applied to the cash-value accumulation test. The guideline level premiums are computed in a manner similar to the computing of the guideline single premium, except that the minimum interest rate is 4% rather than 6%. The death benefit requirement is met if death benefits exceed 250% of the cash value for an insured of attained age up to age 40, grading down to 100% of the cash value at attained age 55. Thus, if a 35 year old owns a cash-value policy whose cash value is $10,000 the policy death benefit must at least be $25,000 for the policy to meet the death benefit requirement. This information is also inputted 22 into the data processing apparatus. A life insurance product is chosen 24 from among all types of life policies, such as whole life, interest sensitive whole life, universal life, variable universal life, and term life. The life insurance may be group life, individual life, corporate-owned life or bank-owned life complete with any desired riders or options. The insured may be a single individual or joint lives may be covered, such as in first-to-die and last-to-die programs. This also is inputted 26 into the data processing apparatus.

Another type of insurance product, program or policy (called here “Long-Term Care”) is chosen 28 from among the following: disability insurance, long-term care insurance, critical illness insurance, accidental death insurance, health insurance, major medical insurance, immediate annuities (fixed or variable), deferred annuities (fixed or variable), property insurance, casualty insurance and global or multi-risk insurance. The next step is to input 30 the Long-Term Care insurance product into the data processing apparatus. Riders and/or options 31 may be selected and inputted if desired. The riders and/or options may be added to the life policy or the long term care policy or both. By way of example only, such riders may include accidental death and dismemberment, waiver of premium in event of disability, spousal and children life insurance, guaranteed insurability option for additional insurance, exchange of insured rider and return of premiums riders for disability and long term care. Thereafter, at least two separate but related policies are formed 32 on the same insured. The terms “policies”, “products”, “programs” and “contracts” refer to life insurance or Long-Term Care contracts, policies, products or programs, or to proposed contracts, policies, products or programs, or to terms for such contracts, policies, products or programs, or outlines of such contracts, policies, products or programs, or any other shorthand variation of a contract, policy, product or program or prospective contract, policy, product or program that one might want to use. For simplicity, the description here will focus on a two contract plan rather than three or more contracts unless so specified. It is to be understood, however, that more than two contracts on the same insured or insureds may be used if desired.

Health insurance may be defined broadly as insurance that includes all types of disability income and medical expenses. Disability insurance may be broadly defined as an insurance contract that pays a regular monthly income, or a lump sum payment, if the insured is disabled by sickness or accident. Major medical insurance may be broadly defined as insurance to offset heavy medical expenses resulting from catastrophic or prolonged illnesses or injuries. Critical illness insurance may be broadly defined as any illness which will ultimately cause the death of the insured or shorten life expectancy, such as cancer, coronary, etc. Long-term care insurance may be broadly defined as insurance to pay for assisted living and nursing care either at home or in an outside facility. Personal property and casualty insurance may be considered insurance to cover the liability related to automobiles, home ownership, rental property, personal liability, general liability and other loss, such as from fire or theft, due to legal liability to third persons. A multi-risk or global policy may include any three or more of the above described coverages.

The benefits and obligations of the two policies are then divided disproportionately 34 between the policies. Nevertheless, the policies are related in the sense that the total premiums paid are used to determine the benefits or coverages of the two policies. However, the share of the insurance company's cost, expenses and profits, which all effect the premiums charged, are disproportionately allocated to the Long-Term Care product thereby making the life product more economical. The Long-Term Care product typically qualifies as a deductible expense to a corporation that is the premium obligor. This disproportional allocation makes the life policy, whose premium is usually paid by the favorite employee, a substantial bargain.

The term “benefits” means essentially the death benefits and cash values, if any, from a life insurance policy and contract payments from a Long-Term Care policy. “Obligations” generally refer to premium payments where the entity or entities required to make premium payments become the obligor or obligors. “Separate but related policies” means that the coverages chosen, including one or more life insurance products and one or more Long-Term Care products are arranged into at least two separate but related contracts on the same insured or insureds. The life insurance contracts will qualify under applicable law as will the remaining contracts should there be applicable laws relating to them. The total benefits of all policies is a function of the total premiums paid on all of the policies. A decrease or lapse of premium payments in one policy will, of course, affect the benefits available under all policies. Also, a future reallocation of premiums and values may occur as changes in regulation occur. However, it is to be emphasized that the two (or more) contracts are separate in that should a first contract lapse for failure of premium payments, that event will not affect the status of the other contract as long as the premium obligation on the other contract is paid. Because, the two contracts are related, the benefits for the remaining policy may have to change.

“Disproportional allocation” means that the allocation of a larger premium obligation is made to one contract while many of the benefits are disproportionally allocated between the other contract or contracts. Thus, an individual may end up paying less in premium but receive excellent coverage because his/her corporation is picking up a disproportionate share of the overall premium obligations, and savings in commission and underwriting may be realized. After forming at least two separate but related policies, the policies are compared 36 with regulatory requirements to ensure compliance. Thereafter, ownership, beneficiary and premium obligors 37 of the related policies are determined. Then the resulting policies are displayed 38.

The advantages obtained from the present invention are that the life policy with all of its inherent tax advantages may be discounted because of the expenses absorbed by the related but separate Long-Term Care policy. The reallocation of expenses and the like will typically result in higher tax deductibilities in those situations where the Long-Term Care coverages are normally deductible as a business expense. For example, health, disability and long-term care insurance are currently tax deductible expenses in certain situations where they are provided as an employee benefit. Efficiencies are also generated for the insurance company because it insures more than one risk with a single underwriting. Also, potential new business is produced for the insurance company by adding the sale of a life insurance product to an employee benefit package. All of these factors enable the insurance company to offer the life policy at a discount when compared to a stand alone policy.

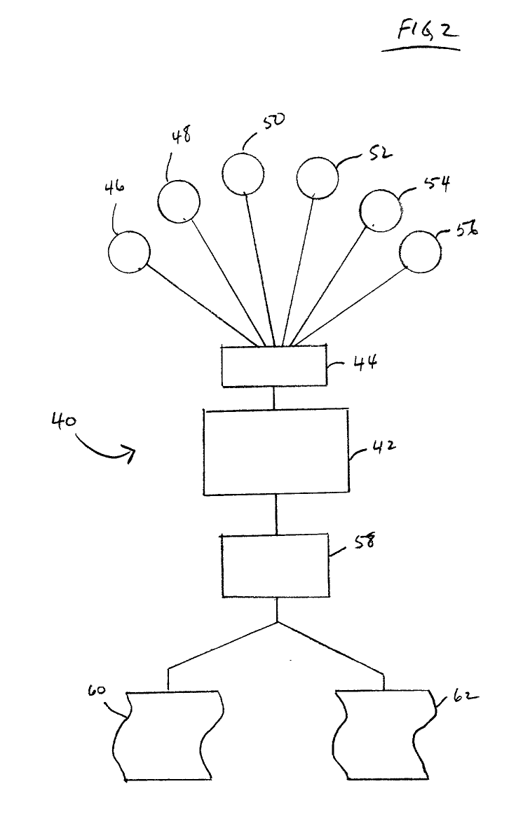

Referring now to FIG. 2, an insurance system 40 of the present invention is illustrated and comprises the data processing apparatus 42 which has an input means 44 for receiving information and instructions. That input means may be a computer keyboard, a program that accepts voice commands or any other device now available or which becomes available in the future to pass information and instructions to the memory of a computer. The data processing apparatus 42 contains the Base Product Data 46, regulatory requirements 48 and information regarding a prospective insured 50. The data processing apparatus 42 also includes information concerning life insurance products 52 and Long-Term Care products 54.

The data processing apparatus further includes instructions 56 for allocating policy expenses, premium obligations and benefits in a disproportional manner between at least one life insurance contract and at least one Long-Term Care insurance contract. Display means 58, such as a computer screen or a printer or any other device that may be developed in the future for displaying information generated by a computer is connected to the data processing apparatus for displaying the resulting separate but related contracts 60, 62.

The specification described in detail two embodiments of the present invention. Other modifications will under the doctrine of equivalents come within the scope of the appended claims. For example, different kinds of computers are available for storing information and different methods for inputting information are also available. Further, methods of displaying information are varied and could include the Internet. These are all considered equivalent structures of the invention disclosed here. Still other alternatives will also be equivalent as will many new technologies. These new technologies may relate to the computer or even new insurance products. There is no desire or intention here to limit in any way the application of the doctrine of equivalents.

1. A method for forming an insurance plan comprising the steps of:
collecting base product data;
inputting said base product data into a data processing apparatus;
collecting data relating to an individual to be insured;
inputting said data about the individual into a data processing apparatus;
collecting regulatory requirements;
inputting said regulatory requirements into a data processing apparatus;
choosing or forming a life insurance product;
inputting said life insurance product choice into a data processing apparatus;
choosing or forming a long-term care product;
inputting said long-term care product choice into a data processing apparatus;
forming in a data processing apparatus at least two separate but related insurance policies;
disproportionately allocating expenses, benefits and obligations regarding said policies among said at least two separate but related policies;
comparing said at least two separate but related policies with said regulatory requirements;
determining ownership, beneficiary and premium obligors of said at least two separate but related policies; and
displaying the resulting related policies.

2. A method as claimed in claim 1 wherein:
base product data includes the probability of an event insured against occurring, the time value of money, the benefits promised, company expenses, company profits and probable contingencies.

3. A method as claimed in claim 1 wherein:
data relating to an individual includes information concerning one or more of the following subjects: his/her sex, age, marital status, individual medical history, family medical history, usage of alcohol, tobacco and drugs, automobile driving record, credit report, financial statement, criminal record, current medical examination report and results, and physical disabilities and impairments.

4. A method as claimed in claim 1 wherein:
life insurance product includes one or more of the following: whole life, interest sensitive whole life, universal life, variable universal life, and term life.

5. A method as claimed in claim 1 wherein:
long-term care includes insurance from one or more of the following coverages: disability insurance, long-term care insurance, critical illness insurance, accidental death insurance, health insurance, major medical insurance, immediate annuities, deferred annuities, other annuities, property insurance, casualty insurance and multi-risk insurance.

6. A method as claimed in claim 2 wherein:
data relating to an individual includes information concerning one or more of the following subjects: his/her sex, age, marital status, individual medical history, family medical history, usage of alcohol, tobacco and drugs, automobile driving record, credit report, financial statement, criminal record, current medical examination report and results, and physical disabilities and impairments.

7. A method as claimed in claim 2 wherein:
life insurance product includes one or more of the following: whole life, interest sensitive whole life, universal life, variable universal life and term life.

8. A method as claimed in claim 2 wherein:
long-term care includes insurance from one or more of the following coverages: disability insurance, long-term care insurance, critical illness insurance, accidental death insurance, health insurance, major medical insurance, immediate annuities, deferred annuities, other annuities, property insurance, casualty insurance and multi-risk insurance.

9. A method as claimed in claim 6 wherein:
life insurance product includes one or more of the following: whole life, interest sensitive whole life, universal life, variable universal life and term life; and
long-term care includes insurance from one or more of the following coverages: disability insurance, long-term care insurance, critical illness insurance, accidental death insurance, health insurance, major medical insurance, immediate annuities, deferred annuities, other annuities, property insurance, casualty insurance and multi-risk insurance.

10. A method as claimed in claim 1 including the step of:
adding a rider or riders and/or an option or options to said life insurance product or said long-term care product or both, such riders including one or more from the group of riders including accidental death dismemberment, waiver of premium in event of disability, spousal and children life insurance, guaranteed insurability option for additional insurance, exchange of insured rider, and return of premiums rider for disability and long term care.

11. A method for forming an insurance plan comprising the steps of:
selecting or forming a life insurance policy;
collecting data about an individual to be insured;
inputting said data about the individual into a data processing apparatus containing information about said life insurance policy;
collecting regulatory requirements;
inputting said regulatory requirements into said data processing apparatus;
selecting a long-term care insurance product;
forming in said data processing apparatus at least two separate but related policies;
disproportionately allocating expenses, benefits and obligations regarding said at least two separate but related policies;
comparing the policies with said regulatory requirements;
determining ownership, beneficiaries and premium obligors of said related policies; and
displaying the resulting related policies.

12. A method as claimed in claim 11 wherein:
data about an individual includes information concerning one or more of the following subjects: his/her sex, age, marital status, individual medical history, family medical history, usage of alcohol, tobacco and drugs, automobile driving record, credit report, financial statement, criminal record, current medical examination report and results, and physical disabilities and impairments.

13. A method as claimed in claim 12 wherein:
long-term care includes insurance from one or more of the following coverages: disability insurance, long-term care insurance, critical illness insurance, accidental death insurance, health insurance, major medical insurance, immediate annuities, deferred annuities, property insurance, casualty insurance and multi-risk insurance.

14. An insurance system comprising:
a data processing apparatus having input means for receiving information and instructions;
said data processing apparatus having base product data, regulatory requirements and information concerning a prospective insured;
said data processing apparatus also having information concerning a life insurance product and a long-term care product;
said data processing apparatus further having inputted instructions allocating premium obligations, expenses and benefits in a disproportional manner between at least one life insurance contract and at least one long-term care insurance contract; and
means connected to said data processing apparatus for displaying the resulting related contracts.

15. An insurance system as claimed in claim 14 wherein:
said data processing apparatus allows a disproportionate allocation of expenses and premium obligations to be made against said long-term care product.

16. An insurance system as claimed in claim 14 wherein:
the calculation of benefits from all separate but related policies are a function of premiums paid on all related contracts.
